(19) United States
(12) Patent Application Publication
(10) Pub. No.: US 2018/0225987 A1
(43) Pub. Date: Aug. 9, 2018

(54) METHOD, SYSTEM, AND NON-TRANSITORY COMPUTER-READABLE RECORDING MEDIUM FOR SUPPORTING LANGUAGE LEARNING

(71) Applicant: Sang Duck CHOI, New York, NY (US)

(72) Inventor: Sang Duck CHOI, New York, NY (US)

(21) Appl. No.: 15/914,068

(22) Filed: Mar. 7, 2018

Related U.S. Application Data
(63) Continuation of application No. PCT/KR2016/009644, filed on Aug. 30, 2016.

(30) Foreign Application Priority Data
Sep. 7, 2015 (KR) 10-2015-0126337

(51) Int. Cl. G09B 19/04

(52) U.S. Cl. CPC G09B 19/04

(57) ABSTRACT

According to one aspect of the invention, there is provided a method for supporting language learning, comprising the steps of: (a) determining a knowing word set including at least one word judged to be known by a learner, with reference to information on a test result of the learner for a predetermined word set, and determining a using word set including at least one word judged to be usable by the learner in conversation, with reference to information on words spoken by the learner in conversation; and (b) determining a learning target word set including at least one word that the learner knows but does not use in conversation, with reference to the knowing word set and the using word set.

### CROSS-REFERENCE TO RELATED APPLICATION(S)

This application is a continuation application of Patent Cooperation Treaty (PCT) international application Serial No. PCT/KR2016/009644, filed on Aug. 30, 2016, which claims priority to Korean Patent Application Serial No. 10-2015-0126337, filed on Sep. 7, 2015. The entire contents of PCT international application Serial No. PCT/KR2016/009644, and Korean Patent Application Serial No. 10-2015-0126337 are hereby incorporated by reference.

### FIELD OF THE INVENTION

The present invention relates to a method, system, and non-transitory computer-readable recording medium for supporting language learning.

### BACKGROUND

With the development of information and communication technology, various learning methods are introduced which assist a learner to perform learning in an online environment like the Internet, contrary to traditional learning methods in which a learner actually meets an instructor to perform learning through the guidance of the instructor. Particularly, in the field of language learning, telephone conversation learning, video conversation learning, or the like utilizing broadband data communication networks and smart devices is actively performed.

However, the conventional techniques introduced so far merely assist a learner to interact with a remote instructor, and fail to fully utilize advantages of high-speed data communication environments and high-performance smart devices in providing learning methods necessary for the learner's word learning.

In this regard, the inventor(s) have developed a technique for effectively supporting word learning of a learner who has a great difference between the level of words that the learner can understand in reading or the like (i.e., words that the learner knows), and the level of words that the learner can practically use in conversation.

### SUMMARY OF THE INVENTION

One object of the present invention is to solve all the above-described problems in prior art.

Another object of the invention is to find out a difference between words that a learner can understand in reading or the like (i.e., knowing words) and words that the learner can use in conversation or the like (i.e., using words), and to effectively provide learning information necessary for the learner on the basis of the difference, by determining a knowing word set including at least one word judged to be known by a learner, with reference to information on a test result of the learner for a predetermined word set, and determining a using word set including at least one word judged to be usable by the learner in conversation, with reference to information on words spoken by the learner in conversation; and determining a learning target word set including at least one word that the learner knows but does not use in conversation, with reference to the knowing word set and the using word set.

The representative configurations of the invention to achieve the above objects are described below.

According to one aspect of the invention, there is provided a method for supporting language learning, comprising the steps of: (a) determining a knowing word set including at least one word judged to be known by a learner, with reference to information on a test result of the learner for a predetermined word set, and determining a using word set including at least one word judged to be usable by the learner in conversation, with reference to information on words spoken by the learner in conversation; and (b) determining a learning target word set including at least one word that the learner knows but does not use in conversation, with reference to the knowing word set and the using word set.

According to another aspect of the invention, there is provided a system for supporting language learning, comprising: a knowing word management unit configured to determine a knowing word set including at least one word judged to be known by a learner, with reference to information on a test result of the learner for a predetermined word set; a using word management unit configured to determine a using word set including at least one word judged to be usable by the learner in conversation, with reference to information on words spoken by the learner in conversation; and a learning target word management unit configured to determine a learning target word set including at least one word that the learner knows but does not use in conversation, with reference to the knowing word set and the using word set.

In addition, there are further provided other methods and systems to implement the invention, as well as non-transitory computer-readable recording media having stored thereon computer programs for executing the methods.

According to the invention, it is possible to find out a difference between words that a learner can understand in reading or the like (i.e., knowing words) and words that the learner can use in conversation or the like (i.e., using words), so that learning information on words that the learner knows but does not use in conversation may be accurately and effectively provided to the learner.

According to the invention, it is possible to find out an amount of word usage, a degree of participation, a conversation-leading capability, or a rate of word usage of a learner in a conversation.

### BRIEF DESCRIPTION OF THE DRAWINGS

FIG. 1 schematically shows the configuration of an entire system for supporting language learning according to one embodiment of the invention.

FIG. 2 illustratively shows the internal configuration of a language learning support system according to one embodiment of the invention.

FIG. 3 conceptually shows relationships between various word sets according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each of the disclosed embodiments may also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

Configuration of an Entire System

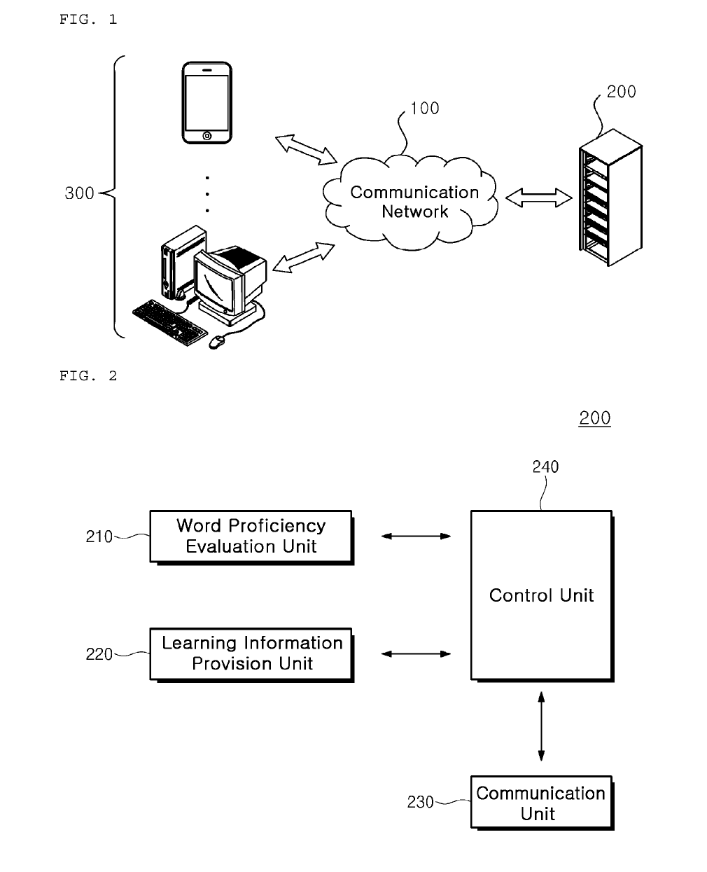

FIG. 1 schematically shows the configuration of an entire system for supporting language learning according to one embodiment of the invention.

As shown in FIG. 1, the entire system according to one embodiment of the invention may comprise a communication network 100, a language learning support system 200, and a user terminal device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television networks.

Next, the language learning support system 200 according to one embodiment of the invention may function to find out a difference between words that a learner can understand in reading or the like (i.e., knowing words) and words that the learner can use in conversation or the like (i.e., using words), and to effectively provide learning information necessary for the learner on the basis of the difference, by determining a knowing word set including at least one word judged to be known by a learner, with reference to information on a test result of the learner for a predetermined word set, and determining a using word set including at least one word judged to be usable by the learner in conversation, with reference to information on words spoken by the learner in conversation; and determining a learning target word set including at least one word that the learner knows but does not use in conversation, with reference to the knowing word set and the using word set.

The configuration and function of the language learning support system 200 according to the invention will be discussed in detail in the following description.

Next, the user terminal device 300 according to one embodiment of the invention is digital equipment capable of allowing a user to connect to and then communicate with the language learning support system 200, and any type of digital equipment having a microprocessor and a memory means for computing capabilities, such as smart phones, tablets, smart watches, smart bands, smart glasses, desktop computers, notebook computers, workstations, personal digital assistants (PDAs), web pads, and mobile phones, may be adopted as the user terminal device 300 according to the invention.

Particularly, the user terminal device 300 may include an application (not shown) to assist a user (i.e., a learner or instructor) to receive services such as language learning from the language learning support system 200. The application may be downloaded from the language learning support system 200 or a known web server (not shown).

Configuration of the Language Learning Support System

Hereinafter, the internal configuration of the language learning support system crucial for implementing the invention and the functions of the respective components thereof will be discussed.

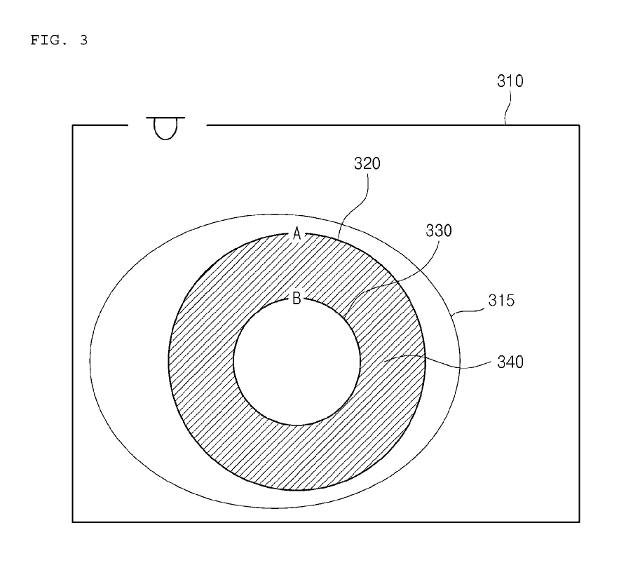

FIG. 2 illustratively shows the internal configuration of the language learning support system according to one embodiment of the invention.

Referring to FIG. 2, the language learning support system 200 according to one embodiment of the invention may comprise a word proficiency evaluation unit 210, a learning information provision unit 220, a communication unit 230, and a control unit 240. Here, the word proficiency evaluation unit 210 may comprise a knowing word management unit (not shown), a using word management unit (not shown), and a learning target word management unit (not shown). According to one embodiment of the invention, at least some of the word proficiency evaluation unit 210, the learning information provision unit 220, the communication unit 230, and the control unit 240 may be program modules to communicate with an external system (not shown). The program modules may be included in the language learning support system 200 in the form of operating systems, application program modules, and other program modules, while they may be physically stored in a variety of commonly known storage devices. Further, the program modules may also be stored in a remote storage device that may communicate with the language learning support system 200. Meanwhile, such program modules may include, but not limited to, routines, subroutines, programs, objects, components, data structures, and the like for performing specific tasks or executing specific abstract data types as will be described below in accordance with the invention.

First, according to one embodiment of the invention, the word proficiency evaluation unit 210 may function to determine a knowing word set (i.e., A (320) of FIG. 3) including at least one word that is judged to be known by a learner (i.e., the meaning of which is judged to be understood by the learner), with reference to information on a test result of the learner for a predetermined word set (i.e., U (310) of FIG. 3).

Here, according to one embodiment of the invention, the predetermined word set may indicate a kind of word database that may be utilized in testing classes, difficulty levels, subjects, fields, and the like of words known by the learner.

Specifically, according to one embodiment of the invention, the predetermined word set may include a must-know word set (315 of FIG. 3) including at least one word judged to be a must-know for the learner. More specifically, the must-know word set may be defined on the basis of words commonly used by native speakers, may be defined by category, or may be categorized according to age, education level, nationality, and the like.

Further, according to one embodiment of the invention, the word proficiency evaluation unit 210 may function to determine a using word set (i.e., B (330) of FIG. 3) including at least one word judged to be usable by the learner in conversation, with reference to information on words spoken by the learner in conversation. Here, the information on words spoken by the learner in conversation may include information on a number, types, frequencies, classes, difficulty levels, subjects, fields, and the like of words spoken by the learner in a conversation.

Specifically, according to one embodiment of the invention, the using word set may not only include words actually used by the learner in conversation, but also include other words having the same meanings as (i.e., synonyms for) the words actually used by the learner in conversation.

Further, according to one embodiment of the invention, the word proficiency evaluation unit 210 may classify words included in each of the predetermined word set, the knowing word set, and the using word set into at least one category according to criterion such as class, difficulty level, subject, and field. Thus, according to one embodiment of the invention, the words known by the learner and the words usable by the learner may be found out by category, respectively.

Hereinafter, the embodiments for categorizing the aforementioned various word sets according to diverse criteria will be discussed in more detail.

Specifically, according to one embodiment of the invention, words may be classified according to difficulty level. For example, words included in a GRE wordbook may be classified into an expert level category, words included in a SAT wordbook may be classified into a college level category, and other words whose frequencies of usage are not lower than a predetermined level may be classified into a high school level category.

Further, according to one embodiment of the invention, words may be classified according to career field. For example, a word (e.g., “adjourned”) included in a line of a character who is a lawyer (e.g., “The court is adjourned.”) among lines in a film or play script may be classified into a lawyer category.

Further, according to one embodiment of the invention, words may be classified according to subject. For example, words such as “neuron” and “synapse” and a sentence such as “Synapse is a gap between neurons.” used in a documentary video may be classified into a category corresponding to a subject, “Science/Life Science/Neuroscience”.

Further, according to one embodiment of the invention, the word proficiency evaluation unit 210 may function to determine a learning target word set (i.e., AnB (340) of FIG. 3) including at least one word that the learner knows but does not use in conversation, with reference to the knowing word set and the using word set as above. According to one embodiment of the invention, the learning target word set determined as above may be dynamically determined according to the learner's learning status.

Further, according to one embodiment of the invention, the word proficiency evaluation unit 210 may classify words included in the learning target word set into at least one category according to criterion such as class, difficulty level, subject, and field. Thus, the words that the learner knows but does not use in conversation may be found out by category.

For example, as for a learner A who has performed a conversation with an instructor for 60 minutes, the word proficiency evaluation unit 210 according to one embodiment of the invention may evaluate that the learner A uses about 100 words, frequently uses specific words, tends to use fewer verbs, mainly uses short-answer sentences, and has a rich vocabulary in social fields but a poor vocabulary in economic and scientific fields. Particularly, the word proficiency evaluation unit 210 according to one embodiment of the invention may evaluate that only about 30% of the words known by the learner are used in conversation.

Next, according to one embodiment of the invention, the learning information provision unit 220 may function to determine learning information to be provided to the learner, with reference to the learning target word set determined as above. Specifically, the learning information provision unit 220 according to one embodiment of the invention may continuously expose the words included in the learning target word set to the learner, so that the learner may effectively learn the words that the learner knows but does not use in conversation.

Further, according to one embodiment of the invention, the learning information provision unit 220 may prioritize the learning information to be provided to the learner, with reference to a frequency of usage, subject relevance, difficulty level, and the like of at least one word included in the learning target word set.

However, the learning information provided in the invention is not necessarily limited to the above embodiments, and it is noted that any words not included in the learning target word set may be provided to the learner, as necessary.

Meanwhile, according to another embodiment of the invention, the word proficiency evaluation unit 210 may function to determine an amount of word usage, a degree of participation or conversation-leading capability, a rate of word usage, and the like of a learner, with reference to information on a duration for which the learner speaks, a number of words that the learner speaks, a rate at which the learner speaks, and the like in a conversation.

Specifically, the word proficiency evaluation unit 210 according to another embodiment of the invention may calculate a total number (l) of words spoken by a learner for a given conversation time, thereby determining an amount of word usage of the learner. Here, noises such as exclamations or incomplete words may be excluded from the words spoken by the learner.

Further, the word proficiency evaluation unit 210 according to another embodiment of the invention may divide a total number (l) of words spoken by a learner for a given conversation time by a sum (l+t) of the total number (l) of words spoken by the learner and a total number (t) of words spoken by an instructor, thereby evaluating a degree of participation or conversation-leading capability (l/(l+t)) of the learner.

Further, the word proficiency evaluation unit 210 according to another embodiment of the invention may calculate a number of words spoken by a learner per unit time for a given conversation time, thereby evaluating a rate of word usage of the learner.

Further, the word proficiency evaluation unit 210 according to another embodiment of the invention may determine an amount of word usage, a degree of participation or conversation-leading capability, a rate of word usage, and the like of a learner, with respect to each unit dialogue constituting a conversation, rather than the entire conversation. Further, the word proficiency evaluation unit 210 according to another embodiment of the invention may determine an amount of word usage, a degree of participation or conversation-leading capability, a rate of word usage, and the like of a learner, with respect to each category (e.g., subject, issue, field, etc.) to which a constituent dialogue belongs.

For example, a degree of participation or conversation-leading capability of the learner in each unit dialogue may be determined by calculating a relative ratio between a total number (In) of words spoken by the learner and a total number (tn) of words spoken by the instructor in each unit dialogue, such as a dialogue that occurs when the instructor first speaks to the learner, or a dialogue that occurs when the learner asks the instructor.

The amount of word usage, degree of participation or conversation-leading capability, rate of word usage, and the like as described above may be repeatedly calculated with a period of a predetermined unit time (e.g., day, week, month, year, etc.), so that the learner's word proficiency may be monitored over time.

Meanwhile, according to one embodiment of the invention, the word proficiency evaluation unit 210 may compare the word proficiency of a learner or learner group with that of another learner or learner group, thereby assisting the learner to find out the level of his/her word proficiency.

Specifically, the word proficiency evaluation unit 210 according to one embodiment of the invention may calculate a relative ratio between a number of words included in a knowing word set and a number of words included in a must-know word set, with respect to each of a plurality of learners or learner groups, and compare the calculated ratios between the learners or learner groups, thereby evaluating how much a learner or learner group knows the must-know words compared to other learners or learner groups.

Further, the word proficiency evaluation unit 210 according to one embodiment of the invention may calculate a relative ratio between a number of words included in a using word set and a number of words included in a knowing word set, with respect to each of a plurality of learners or learner groups, and compare the calculated ratios between the learners or learner groups, thereby evaluating how many of the knowing words are actually used by a learner or learner group compared to other learners or learner groups.

Meanwhile, according to one embodiment of the invention, the word proficiency evaluation unit 210 may provide information on how a word proficiency of a learner (e.g., a relative ratio between a number of words included in a knowing word set and a number of words included in a must-know word set, or a relative ratio between a number of words included in a using word set and a number of words included in a knowing word set, as mentioned above) is changed over time (or as variables such as a number of classes, a frequency of learning, and a participation rate are changed).

For example, the word proficiency evaluation unit 210 according to one embodiment of the invention may provide a first learner with information on a course of changes in a word proficiency of a second learner whose relative ratio between a number of words included in a knowing word set and a number of words included in a must-know word set was similar to that of the first learner at a specific time (i.e., information on how the knowing word set or the using word set is expanded as predetermined variables are changed).

Meanwhile, according to one embodiment of the invention, the communication unit 230 may function to enable the language learning support system 200 to communicate with an external device such as the user terminal device 300.

Lastly, according to one embodiment of the invention, the control unit 240 may function to control data flow among the word proficiency evaluation unit 210, the learning information provision unit 220, and the communication unit 230. That is, the control unit 240 may control inbound data flow or data flow among the respective components of the language learning support system 200, such that the word proficiency evaluation unit 210, the learning information provision unit 220, and the communication unit 230 may carry out their particular functions, respectively.

The embodiments according to the invention as described above may be implemented in the form of program instructions that can be executed by various computer components, and may be stored on a non-transitory computer-readable recording medium. The non-transitory computer-readable recording medium may include program instructions, data files, data structures and the like, separately or in combination. The program instructions stored on the non-transitory computer-readable recording medium may be specially designed and configured for the present invention, or may also be known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for supporting language learning, comprising the steps of:
(a) determining a knowing word set including at least one word judged to be known by a learner, with reference to information on a test result of the learner for a predetermined word set, and determining a using word set including at least one word judged to be usable by the learner in conversation, with reference to information on words spoken by the learner in conversation; and
(b) determining a learning target word set including at least one word that the learner knows but does not use in conversation, with reference to the knowing word set and the using word set.

2. The method of claim 1, wherein the predetermined word set includes a must-know word set including at least one word judged to be a must-know for the learner.

3. The method of claim 1, wherein the using word set includes synonyms for words actually used by the learner in conversation.

4. The method of claim 1, wherein the information on words spoken by the learner in conversation includes information on at least one of a number, types, frequencies, classes, difficulty levels, subjects, and fields of words spoken by the learner in a conversation.

5. The method of claim 1, wherein in the step (a), words included in each of the predetermined word set, the knowing word set, and the using word set are classified into at least one category according to at least one of class, difficulty level, subject, and field, and
wherein in the step (b), the learning target word set is determined with respect to each category.

6. The method of claim 1, wherein the learning target word set is dynamically determined according to the learner's learning status.

7. The method of claim 1, further comprising the step of:
(c) determining learning information to be provided to the learner, with reference to the learning target word set.

8. The method of claim 7, wherein in the step (c), the learning information to be provided to the learner is prioritized with reference to at least one of a frequency of usage, subject relevance, and difficulty level of at least one word included in the learning target word set.

9. The method of claim 1, further comprising the step of:
(d) determining at least one of an amount of word usage, a degree of participation or conversation-leading capability, and a rate of word usage of the learner, with reference to information on at least one of a duration for which the learner speaks, a number of words that the learner speaks, and a rate at which the learner speaks in a conversation.

10. The method of claim 9, wherein in the step (d), at least one of the amount of word usage, the degree of participation or conversation-leading capability, and the rate of word usage of the learner is determined with respect to each of dialogues constituting the conversation.

11. The method of claim 1, further comprising the step of:
(e) comparing information on a word proficiency of a first learner evaluated on the basis of at least one of the knowing word set, the using word set, and the learning target word set of the first learner, and information on a word proficiency of a second learner evaluated on the basis of at least one of the knowing word set, the using word set, and the learning target word set of the second learner.

12. The method of claim 1, further comprising the step of:
(f) comparing information on a word proficiency of a first or second learner evaluated on the basis of at least one of the knowing word set, the using word set, and the learning target word set of the first or second learner at a first time, and information on a word proficiency of the first or second learner evaluated on the basis of at least one of the knowing word set, the using word set, and the learning target word set of the first or second learner at a second time.

13. A non-transitory computer-readable recording medium having stored thereon a computer program for executing the method of claim 1.

14. A system for supporting language learning, comprising:
a knowing word management unit configured to determine a knowing word set including at least one word judged to be known by a learner, with reference to information on a test result of the learner for a predetermined word set;
a using word management unit configured to determine a using word set including at least one word judged to be usable by the learner in conversation, with reference to information on words spoken by the learner in conversation; and
a learning target word management unit configured to determine a learning target word set including at least one word that the learner knows but does not use in conversation, with reference to the knowing word set and the using word set.

15. The system of claim 14, wherein the predetermined word set includes a must-know word set including at least one word judged to be a must-know for the learner.

16. The system of claim 14, wherein the using word set includes synonyms for words actually used by the learner in conversation.

17. The system of claim 14, wherein the information on words spoken by the learner in conversation includes information on at least one of a number, types, frequencies, classes, difficulty levels, subjects, and fields of words spoken by the learner in a conversation.

18. The system of claim 14, wherein words included in each of the predetermined word set, the knowing word set, and the using word set are classified into at least one category according to at least one of class, difficulty level, subject, and field, and
wherein the learning target word set is determined with respect to each category.

19. The system of claim 14, wherein the learning target word set is dynamically determined according to the learner's learning status.

20. The system of claim 14, further comprising:
a learning information provision unit configured to determine learning information to be provided to the learner, with reference to the learning target word set.

21. The system of claim 20, wherein the learning information provision unit is configured to prioritize the learning information to be provided to the learner, with reference to at least one of a frequency of usage, subject relevance, and difficulty level of at least one word included in the learning target word set.

22. The system of claim 14, wherein at least one of an amount of word usage, a degree of participation or conversation-leading capability, and a rate of word usage of the learner is determined with reference to information on at least one of a duration for which the learner speaks, a number of words that the learner speaks, and a rate at which the learner speaks in a conversation.

23. The system of claim 22, wherein at least one of the amount of word usage, the degree of participation or conversation-leading capability, and the rate of word usage of the learner is determined with respect to each of dialogues constituting the conversation.

24. The system of claim 14, wherein information on a word proficiency of a first learner evaluated on the basis of at least one of the knowing word set, the using word set, and the learning target word set of the first learner is compared with information on a word proficiency of a second learner evaluated on the basis of at least one of the knowing word set, the using word set, and the learning target word set of the second learner.

25. The system of claim 14, wherein information on a word proficiency of a first or second learner evaluated on the basis of at least one of the knowing word set, the using word set, and the learning target word set of the first or second learner at a first time is compared with information on a word proficiency of the first or second learner evaluated on the basis of at least one of the knowing word set, the using word set, and the learning target word set of the first or second learner at a second time.
